(19) United States
(12) Patent Application Publication
(10) Pub. No.: US 2009/0312869 A1
(43) Pub. Date: Dec. 17, 2009

(54) ROBOT, ROBOT CONTROL METHOD, AND ROBOT CONTROL PROGRAM

(75) Inventor: Shinichi Ohnaka, Tokyo (JP)

Correspondence Address: DICKSTEIN SHAPIRO LLP, 1633 Broadway, NEW YORK, NY, 10019, US

(73) Assignee: Nec Corporation, Tokyo (JP)

(21) Appl. No.: 12/306,597

(22) PCT Filed: Jun. 25, 2007
(86) PCT No.: PCT/JP2007/000683

§ 371 Date: Feb. 9, 2009

(30) Foreign Application Priority Data
Jun. 28, 2006 (JP) 2006-177534

(51) Int. Cl. B25J 19/04

(52) U.S. Cl. 700/253; 700/259; 700/250; 901/47

(57) ABSTRACT

A robot 100 includes an image input means 201 that receives an image and outputs image data, an image processing means 202 that receives the image data and generates and outputs an image recognition result, a restraint processing means 204 that outputs an operation instruction for altering a behavior while the image processing means 202 performs a process for identifying or registering a person's face, and an operation means 205 that is operated on the basis of the operation instruction.

### TECHNICAL FIELD

The present invention relates to a robot, a robot control method, and a robot control program, and more particularly, to a robot, a robot control method, and a robot control program that identify or register a person while interacting with the person.

### BACKGROUND ART

In the past, there has been a technique for a robot that senses the presence of a person (refer to Patent Document 1). If a robot recognizes the presence of a person, the operation of the robot is stopped or restrained in this technique.

Further, there has been Personal Robot PaPeRo (registered trademark) as an example of a robot in the related art that can recognize a face by using an image taken by a camera and includes an operation means to move the camera (Non-Patent Document 1).

A face recognizing method of Personal Robot PaPeRo is as follows: initially, a program proceeds to a mode for registering a face. Voice recognition is used as a proceeding means. When the program proceeds to a mode for registering a face, a name of a person to be registered is designated. If the name is designated, a face of a person being in front of a CCD camera is automatically registered. Further, when face identification is performed, a program proceeds to a mode for identifying a face so that the face identification is performed in the mode.

Patent Document 1: Japanese Unexamined Patent Application Publication No. S60-217086

Non-Patent Document 1: “Creating a robot culture” published by personal Robot Research Center, NEC Media and Information Research Laboratories, [online], [searched on Jun. 26, 2006], Internet

<URL: http://www.incx.nec.co.jp/robot/robotcenter.html>

### DISCLOSURE OF THE INVENTION

The technique of the robot in the related art has a problem in that a person's face cannot be registered or identified (who he/she is) while the robot interacts with a person.

The reason for this is as follows: in a technique of non-Patent Document 1, a movable portion of the robot is moved in order to present pleasing interaction when the robot interacts with a person. Accordingly, a camera is also moved due to this movement. For this reason, an image taken by the camera is out of focus. Accordingly, if face registration or face identification is performed using this image, accuracy deteriorates.

Further, in a technique of Patent Document 1, if the presence of a person is recognized, all of operations are stopped and restrained. Therefore, it is not possible to achieve an interaction with a person.

An object of the present invention is to solve the problems in the related art, and to provide a robot, a robot control method, and a robot control program that can register or identify a person's face even though interacting with the person.

According to the present invention, there is provided a robot. The robot includes an image input unit that receives an image and outputs image data, an image processing unit that receives the image data and generates and outputs an image recognition result, an operation deciding unit that outputs an operation instruction for altering a behavior while the image processing unit performs a process for identifying or registering a person's face, and an operation unit that is operated on the basis of the operation instruction.

The robot may further include a behavior processing unit that decides a behavior and outputs a behavioral instruction. The operation deciding unit may include a restraint processing unit that receives the behavioral instruction, alters the behavioral instruction so as to restrain the movement of the image input unit, and outputs the altered behavioral instruction as an operation instruction while the image processing unit performs a process for identifying or registering a person's face.

In the robot, the restraint processing unit may alter the behavioral instruction so that the person's face does not deviate from the image, and may output the altered behavioral instruction as the operation instruction while the image processing unit performs the process for identifying or registering the person's face.

In the robot, while the image processing unit may perform the process for identifying or registering the person's face, the restraint processing unit may alter the behavioral instruction so that the moving speed of the image input unit caused by the execution of the operation instruction has a predetermined value as an upper limit, and may output the altered behavioral instruction as the operation instruction.

In the robot, the image input unit may be a CCD camera. The image processing unit may include an image recognition unit that identifies or registers the person's face of the image data output from the CCD camera and outputs restraint information, which requires the alteration or restraint of an operation if a process for identifying or registering a person's face is being performed. The operation deciding unit may include a microphone that collects voice and outputs voice data; a voice recognition unit that receives the voice data, recognizes voice, and outputs the voice as a voice recognition result; a behavior deciding unit that sequentially decides behaviors on the basis of the voice recognition result and outputs the behavior as a behavioral instruction; and an operation restraining unit that outputs an operation instruction which is obtained by altering the behavioral instruction so as to restrain the operation of the CCD camera if the behavioral instruction and the restraint information are input. The operation unit may include a control unit that controls an actuator on the basis of the operation instruction.

The robot may further include a storage unit and a behavior deciding unit. The storage unit stores an operation instruction that can be executed while the image processing unit performs the process for identifying or registering the person's face, and an operation instruction that can be executed while processes for identifying and registering the person's face are not performed. The behavior deciding unit selects and outputs an operation instruction, which can be executed while the image processing unit performs the process for identifying or registering the person's face, from the storage unit if the image processing unit is performing the process for identifying or registering the person's face, and selects and outputs an operation instruction, which can be executed while processes for identifying and registering the person's face are not performed, from the storage unit if the processes for identifying and registering the person's face are not being performed.

In the robot, the image input unit may be a CCD camera, and the image processing unit may include an image recognition unit that identifies or registers the person's face of the image data output from the CCD camera and outputs an image recognition result. The robot may further include a storage unit that stores an operation instruction that restrains the operation of the CCD camera and can be executed while the image processing unit performs the process for identifying or registering the person's face, and an operation instruction that does not restrain the operation of the CCD camera and can be executed while processes for identifying and registering the person's face are not performed. The operation deciding unit may include a microphone that collects voice and output voice data; a voice recognition unit that receives the voice data, recognizes voice, and output the voice as a voice recognition result; and a behavior deciding unit that selects and outputs an operation instruction, which that restrains the operation of the CCD camera and can be executed while the image processing unit performs the process for identifying or registering the person's face, from the storage unit if it is determined from the image recognition result that the image processing unit is performing the process for identifying or registering the person's face, and selects and outputs an operation instruction, which does not restrain the operation of the CCD camera and can be executed while processes for identifying and registering the person's face are not performed, from the storage unit if it is determined that processes for identifying and registering the person's face are not being performed. The operation unit may include a control unit that controls an actuator on the basis of the operation instruction.

According to the present invention, there is provided a robot control method of controlling a robot. The robot includes an image input unit that receives an image and outputs image data, an image processing unit that receives the image data and generates and outputs an image recognition result, and an operation unit that is operated on the basis of an operation instruction. The robot control method includes receiving an image and outputting image data by the image input unit, receiving the image data and generating and outputting an image recognition result by the image processing unit, outputting an operation instruction that alters a behavior while the image processing unit performs a process for identifying or registering a person's face, and operating the operation unit on the basis of the operation instruction.

The robot control method may further include deciding a behavior and outputting a behavioral instruction; receiving the behavioral instruction, altering the behavioral instruction so as to restrain the movement of the image input unit, and outputting the altered behavioral instruction as an operation instruction while the image processing unit performs the process for identifying or registering the person's face; and operating the operation unit on the basis of the operation instruction.

The robot control method may further include altering the behavioral instruction so that the person's face does not deviate from the image, and outputting the altered behavioral instruction as the operation instruction while the image processing unit performs the process for identifying or registering the person's face.

The robot control method may further include altering the behavioral instruction so that the moving speed of the image input unit caused by the execution of the operation instruction has a predetermined value as an upper limit, and outputting the altered behavioral instruction as the operation instruction while the image processing unit performs the process for identifying or registering the person's face.

According to the present invention, there is provided a robot control program that is executed by a computer and controls a robot. The robot includes an image input unit that receives an image and outputs image data, an image processing unit that receives the image data and generates and outputs an image recognition result, and an operation unit that is operated on the basis of an operation instruction. The computer may function as a means that makes the image input unit receive an image and output image data, a means that makes the image processing unit receives the image data and generate and output an image recognition result, a means that outputs an operation instruction for altering a behavior while the image processing unit performs a process for identifying or registering a person's face, and a means that operates the operation unit on the basis of the operation instruction.

In the robot control program, the computer may function as a means that decides a behavior and outputs a behavioral instruction; a means that receives the behavioral instruction, alters the behavioral instruction so as to restrain the movement of the image input unit if the image processing unit is performing the process for identifying or registering the person's face, and outputs the altered behavioral instruction as an operation instruction; and a means that operates the operation unit on the basis of the operation instruction.

In the robot control program, the computer may function as a means that alters the behavioral instruction so that the person's face does not deviate from the image, and outputs the altered behavioral instruction as the operation instruction while the image processing unit performs the process for identifying or registering the person's face.

In the robot control program, the computer may function as a means that alters the behavioral instruction so that the moving speed of the image input unit caused by the execution of the operation instruction has a predetermined value as an upper limit, and outputs the altered behavioral instruction as the operation instruction while the image processing unit performs the process for identifying or registering the person's face.

Meanwhile, even though being changed into a method, an apparatus, a system, a recording medium, a computer program, or the like, arbitrary combination of the components and the representation of the present invention are effective as an aspect of the present invention.

The present invention may be widely applied to a robot that includes an image input device such as a camera and interacts with a person.

The present invention has an advantage of registering or identifying a person's face (who he/she is) even though the robot interacts with a person.

The reason for this is that it is possible to restrain the movement of an image input means during a process for registering or identifying a face.

### BRIEF DESCRIPTION OF THE DRAWINGS

FIG. 1 is a block diagram showing the configuration of a first embodiment of the present invention.

FIG. 2 is a view showing the appearance of a robot of a second embodiment of the present invention.

FIG. 3 is a block diagram showing an example of the internal configuration of the robot shown in FIG. 2.

FIG. 4 is a block diagram showing an example of the mechanical configuration of a controller shown in FIG. 3.

FIG. 5 is a flowchart illustrating the operation of the second embodiment of the present invention.

FIG. 6 is a block diagram showing an example of the mechanical configuration of a controller of a third embodiment of the present invention.

FIG. 7 is a flowchart illustrating the operation of the third embodiment of the present invention.

### BEST MODE FOR CARRYING OUT THE INVENTION

### First Embodiment

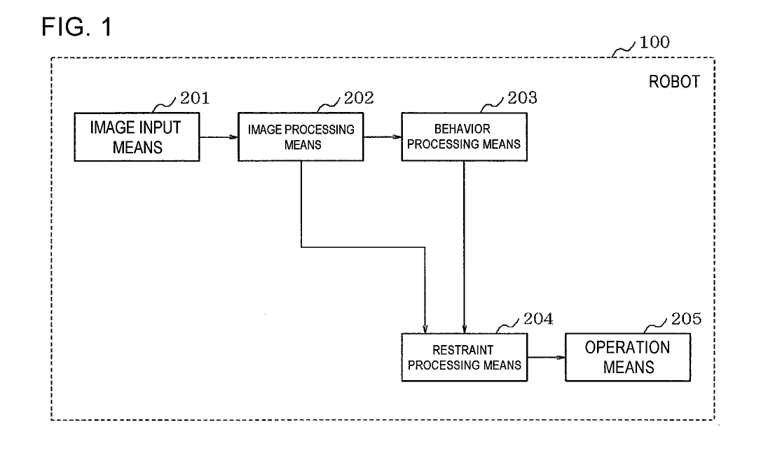

A first embodiment of the present invention will be described in detail below with reference to drawings. FIG. 1 is a block diagram showing the configuration of a first embodiment of the present invention. A robot 100 of a first embodiment of the present invention receives an external image (for example, a background (ground) and an object (figure). An image varies), and alters or restrains an operation during the process for registering or identifying an object (for example, who he/she is). Referring to FIG. 1, the robot 100 includes an image input means 201, an image processing means 202, a behavior processing means 203, a restraint processing means 204, and an operation means 205.

The image input means 201 receives an external image (for example, uses light as a medium), converts the external image into image data, and outputs the image data. The image processing means 202 receives the image data output from the image input means 201, recognizes the situation of the object (for example, person), and generates and outputs an image recognition result.

For example, since an object is not newly identified or registered if it is recognized that the same object continues to exist in the image data, the image recognition result is restraint information that represents “Do not restrain an operation”. Further, since an object is newly identified or registered if it is recognized that a new object appears in the image data, the image recognition result is restraint information that represents “Restrain an operation (for example, restrain an operation for moving a head in order to accurately identify the object)”.

Furthermore, the image recognition result is, for example, state recognizing information where an object is specified. The restraint information is output to the restraint processing means 204. The state recognizing information is output to the behavior processing means 203.

The behavior processing means 203 autonomously (or non-autonomously) decides the behavior (operation) of the robot 100 and outputs a behavioral instruction to the restraint processing means 204. The behavioral instruction is, for example, information that represents “Move the image input means 201 of the robot 100”. The restraint processing means 204 generates an operation instruction on the basis of the behavioral instruction from the behavior processing means 203 and the image recognition result from the image processing means 202, and outputs the operation instruction.

If the combination of the image recognition result and the behavioral instruction corresponds to a predetermined restraint condition, the restraint processing means 204 alters the behavioral instruction from the behavior processing means 203 and outputs the altered behavioral instruction as an operation instruction. For example, if the image recognition result corresponds to “Restrain an operation” and the behavioral instruction of “Move the image input means 201 of the robot 100”, the restraint processing means 204 alters the behavioral instruction to “Move the image input means 201 of the robot 100 less than usual” and outputs the altered behavioral instruction as an operation instruction. Alternatively, the restraint processing means 204 restrains the processing of a behavior and does not output the operation instruction.

The operation means 205 performs an operation (for example, an operation for moving the image input means 201 of the robot 100 less than usual, and, for example, an operation where an object is moved not to deviate from an image) on the basis of the operation instruction output from the restraint processing means 204.

For example, if the image input means 201 is mounted in the head of the robot 100, a behavioral instruction of “Move the image input means 201 of the robot 100” may become “Move the head of the robot 100”.

According to the first embodiment of the present invention, an external image is input and a behavior is altered or restrained during the process for registering or identifying an object. Accordingly, it is possible to obtain an advantage of registering or identifying a person's face (who he/she is) even when the robot interacts with a person.

### Second Embodiment

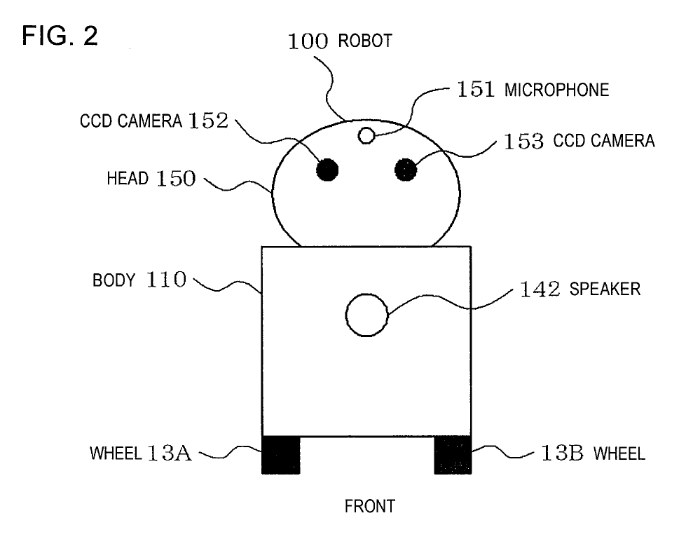

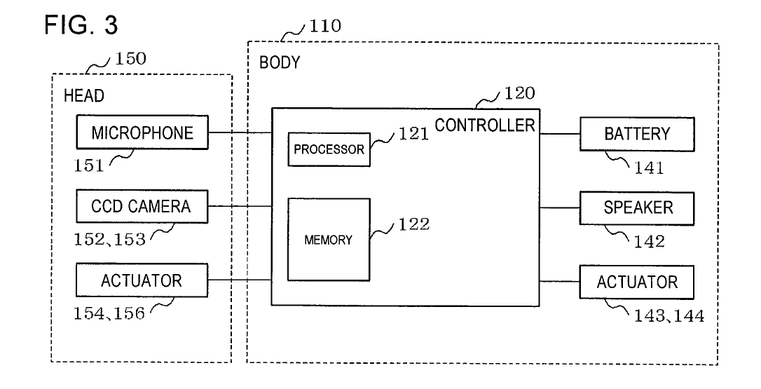

A second embodiment of the present invention will be described in detail below with reference to drawings. FIG. 2 is a view showing the appearance of a robot 100 of a second embodiment of the present invention. FIG. 3 is a block diagram showing an example of the internal configuration of the robot 100. Referring to FIG. 2, the robot 100 includes, for example, a body 110 and a head 150 that are connected to each other.

The body 110 has a cylindrical shape, and flat surfaces of the body are disposed at upper and lower sides thereof. Wheels 13A and 13B are provided on left and right sides at the lower portion of the body 110, and the wheels 13A and 13B can be independently rotated back and forth. The head 150 can be rotated with in the range that is defined about a vertical shaft vertically fixed to the body 110 and a horizontal shaft provided at an angle of 90° with respect to the vertical shaft.

The vertical shaft is provided so as to pass through the center of the head 150, and the horizontal shaft is provided so as to pass through the center of the head 150 and be horizontal in a left and right direction while the body 110 and the head 150 face the front side. That is, the head 150 can be rotated within the range that is defined by two degrees of freedom in horizontal and vertical directions.

A controller 120 for controlling the entire robot 100, a battery 141 used as a power source of the robot 100, a speaker 142, and actuators 143 and 144 for driving the two wheels 13A and 13B, and the like are received in the body 110. A microphone 151, CCD cameras 152 and 153, and actuators 154 and 156 used to rotate the head 150, and the like are received in the head 150.

The microphone 151 of the head 150 collects surrounding voice that includes a user's utterance, and outputs an obtained voice signal (voice data) to the controller 120. The CCD cameras 152 and 153 of the head 150 image a surrounding situation, and send obtained image signals to the controller 120.

Referring to FIG. 3, the controller 120 includes a processor 121 and a memory 122 therein. The processor 121 performs various processes by executing a control program that is stored in the memory 122. That is, the controller 120 determines the surrounding situation or an instruction, which is input from a user, on the basis of the voice and image signals that are output from the microphone 151 and the CCD cameras 152 and 153.

In addition, the controller 120 decides a successive behavior on the basis of the determination result and the like, and drives necessary actuators among the actuators 143, 144, 154, and 156 on the basis of the decision result. Accordingly, an operation for vertically and horizontally rotating the head 150, an operating for moving or rotating the robot 100, or the like is performed. Further, as occasion demands, the controller 120 generates synthesized sound and provides the synthesized sound to the speaker 142 so as to make the synthesized sound be output.

In this way, the robot 100 autonomously behaves on the basis of the surrounding situation and the like. The CCD cameras 152 and 153 correspond to an example of the image input means 201 shown in FIG. 1.

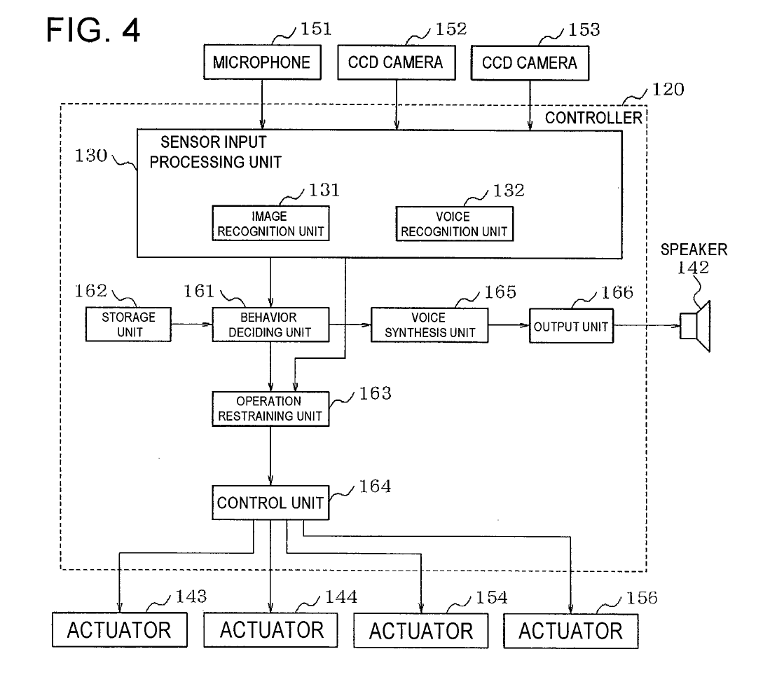

Next, the controller 120 will be described in detail with reference to the drawings. FIG. 4 is a block diagram showing an example of the mechanical configuration of the controller 120 shown in FIG. 3. Meanwhile, the processor 121 executes the control program stored in the memory 122, so that the mechanical configuration shown in FIG. 4 is achieved.

Referring to FIG. 4, the controller 120 includes a sensor input processing unit 130, a behavior deciding unit 161, a storage unit 162, an operation restraining unit 163, a control unit 164, a voice synthesis unit 165, and an output unit 166. The sensor input processing unit 130 includes an image recognition unit 131 and a voice recognition unit 132. The image recognition unit 131 corresponds to an example of the image processing means 202 shown in FIG. 1. The combination of the voice recognition unit 132, the behavior deciding unit 161, and the storage unit 162 corresponds to an example of the behavior processing means 203 shown in FIG. 1. The operation restraining unit 163 corresponds to an example of the restraint processing means 204 shown in FIG. 1. The combination of the control unit 164 and the actuators 143, 144, 154, and 156 corresponds to an example of the operation means 205 shown in FIG. 1.

The sensor input processing unit 130 recognizes a specific external state. The behavior deciding unit 161 sequentially decides behaviors on the basis of the recognition result of the sensor input processing unit 130, and outputs a behavioral instruction. The operation restraining unit 163 alters or restrains the behavioral instruction, which is output from the behavior deciding unit 161, on the basis of the processing situation of the sensor input processing unit 130. The control unit 164 controls the actuators 143, 144, 154, and 156 on the basis of the operation instruction output from the operation restraining unit 163. The voice synthesis unit 165 generates synthesized sound. The output unit 166 controls the output of the synthesized sound that is synthesized by the voice synthesis unit 165. The storage unit 162 stores the behavior of the robot 100.

The sensor input processing unit 130 recognizes a specific external state or a specific movement of a user on the basis of the voice and image signals that are output from the microphone 151 and the CCD cameras 152 and 153, and outputs state recognizing information, which represents the recognition result, to the behavior deciding unit 161.

That is, the image recognition unit 131 performs an image recognition processing by using the image signals that are obtained from the CCD cameras 152 and 153. The image recognition unit 131 can detect a person existing in the image, register a face of the detected person, and identify which registered face the face of the detected person corresponds to. The image recognition unit 131 outputs image recognition results, such as “A person is in front of a camera”, “A registered ID of the person”, and “A position of the person in an image”, to the behavior deciding unit 161 as the state recognizing information. If a plurality of persons exists in an image, the image recognition unit 131 makes the state recognizing information include the information about the plurality of detected persons.

Further, during the process for registering or identifying a person, the image recognition unit 131 outputs restraint information, which requires the alteration or restraint of an operation, to the operation restraining unit 163.

The processing of the image recognition unit 131 (processes for detecting a person and identifying or registering a face of the detected person) is autonomously performed. That is, the processing of the image recognition unit is performed regardless of the operations of the voice recognition unit 132 and the behavior deciding unit 161. In addition, the identification or registration processing of the image recognition unit 131 is not always performed. That is, if a person is detected, an identification or registration processing is performed. However, as long as the person is not changed afterward, the identification or registration processing does not need to be newly performed.

For example, if a person is continuously detected after the detection of a person, the image recognition unit 131 grasps that the same person exists in the image by momentarily checking the position information of the detected person. Accordingly, if the person is the same person, the identification or registration processing does not need to be newly performed. Meanwhile, if a person is not detected at a certain moment after the continuous detection of a person, a non-detection time has passed over a predetermined time, and a person is detected again, the identification or registration processing is newly performed.

The voice recognition unit 132 performs the voice recognition about the voice signal output from the microphone 151. The voice recognition unit 132 sends words, such as “Good morning” or “Good afternoon”, which is a voice recognition result, to the behavior deciding unit 161 as the state recognizing information.

The behavior deciding unit 161 refers to the storage unit 162 and sequentially decides behaviors on the basis of the state recognizing information output from the sensor input processing unit 130. The behavior deciding unit 161 outputs the contents the decided behaviors to the operation restraining unit 163 as the behavioral instruction, and outputs the contents the decided behaviors to the voice synthesis unit 165 as a synthesized utterance instruction.

The behavior deciding unit 161 receives the voice recognition result, such as “Good morning” or “Good afternoon”, from the image recognition unit 131 as the state recognizing information. Further, the behavior deciding unit 161 receives an image recognition result, such as “One person exists” or “An ID of the person is k”, from the image recognition unit 131 as the state recognizing information. If the voice recognition result is input, the behavior deciding unit 161 refers to the storage unit 162 and obtains the operational information of the robot 100 corresponding to the voice recognition result. Further, if the image recognition result is input, the behavior deciding unit 161 refers to the storage unit 162 and acquires the name of the person, who corresponds to the ID included in the image recognition result.

The operational information of the robot 100, which is stored in the storage unit 162, includes the synthesized utterance instruction and the behavioral instruction of the robot 100. The synthesized utterance instruction includes the contents to be uttered by the robot 100. For example, the synthesized utterance instruction includes instructions, which utter the utterance of string information to be uttered and the name of a currently detected person, or the combination thereof. Further, the storage unit 162 stores the name of the person who corresponds to the ID obtained as the image recognition result. That is, it is possible to obtain the name of a person from an ID.

If the operational information of the robot 100 is input from the storage unit 162, the behavior deciding unit 161 outputs a synthesized utterance instruction to the voice synthesis unit 165 and outputs a behavioral instruction of the robot 100 to the operation restraining unit 163.

For example, the behavioral instruction of the robot 100, which corresponds to the voice recognition result of “Good morning”, has the contents where the head 150 is shaken up and down and faces the front side. The synthesized utterance instruction has the contents where the robot utters a person's name if the robot initially knows the person's name and then makes a synthesized utterance of “Good morning”.

If the behavior deciding unit 161 receives a voice recognition result of “Good morning” as the state recognizing information, the behavior deciding unit 161 outputs a behavioral instruction, which has the contents of “A head 150 is shaken up and down and faces the front side”, to the operation restraining unit 163. Further, the behavior deciding unit 161 outputs a synthesized utterance instruction, which has the contents of “A person's name is initially uttered and a synthesized utterance of ‘Good morning’ is then made”, to the voice synthesis unit 165.

If the behavioral instruction is input from the behavior deciding unit 161, the operation restraining unit 163 receives the restraint information that is output from the image recognition unit 131. The operation restraining unit 163 checks whether the image recognition unit 131 is performing a process for registering the face of a person being in front of the CCD cameras 152 and 153 or is performing a process for identifying the face of the person being in front of the CCD cameras 152 and 153. In these cases, if the robot 100 performs an operation for shaking the head 150 up and down and making the head face the front side, the CCD cameras 152 and 153 are also operated together with the operation of the head 150. For this reason, image data to be input to the image recognition unit 131 is out of focus due to the operation of the CCD cameras 152 and 153.

If the image data is out of focus, it is highly likely that the robot 100 could not correctly register face data or cannot correctly identify the face. Further, if the image recognition unit 131 is performing a process for registering the face of a person being in front of the CCD cameras 152 and 153 or is performing a process for identifying the face of the person being in front of the CCD cameras 152 and 153, the operation restraining unit 163 alters the behavioral instruction output from the behavior deciding unit 161 and outputs an operation instruction. The contents of the alteration is, for example, (1) to prevent the person's face from deviating from an image during the registration or identification even though the CCD cameras 152 and 153 are moved, and (2) to prevent the moving speed of the CCD cameras 152 and 153 (that is, head 150) from exceeding a predetermined speed.

The control unit 164 generates control signals, which are used to drive the actuators 143, 144, 154, and 156, on the basis of the operation instruction output from the operation restraining unit 163, and outputs the control signals to the actuators 143, 144, 154, and 156. The actuators 143, 144, 154, and 156 are driven according to the control signals, and the robot 100 autonomously behaves.

If a synthesized utterance instruction is input from the behavior deciding unit 161, the voice synthesis unit 165 generates digital data of synthesized sound on the basis of the synthesized utterance instruction and outputs the digital data. The output unit 166 converts digital data, which is output from the voice synthesis unit 165, into an analog voice signal, and outputs the analog voice signal to the speaker 142. The speaker 142 receives the analog voice signal and outputs voice.

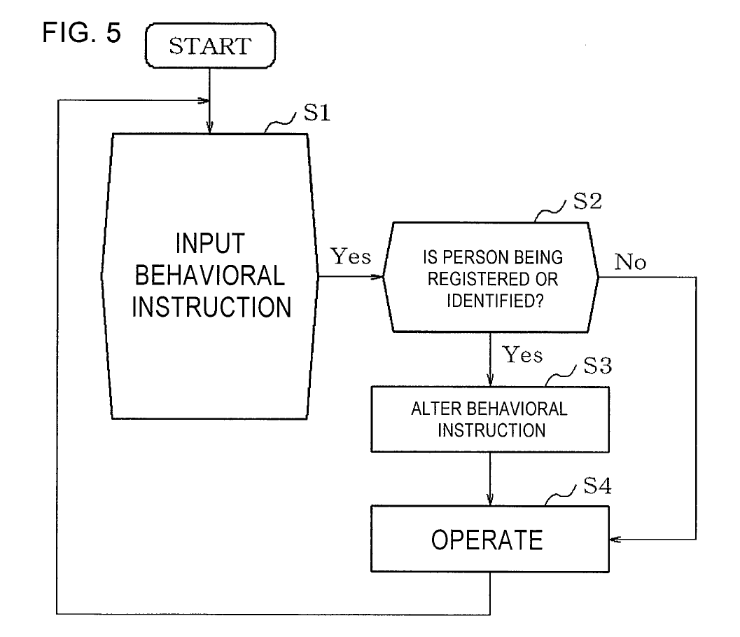

Next, the entire operation of a second embodiment of the present invention will be described in detail with reference to a flowchart of FIG. 5. If a behavioral instruction (for example, by voice) is input (Yes in Step S1 of FIG. 5), the robot 100 determines whether a person is being registered or identified (Step S2). If it is determined that the person is being registered or identified (Yes in Step S2), the robot 100 generates an operation instruction by altering a behavioral instruction (Step S3). Then, the robot 100 is operated on the basis of the operation instruction (Step S4).

According to the second embodiment of the present invention, when a person is being registered or identified, the movement of the CCD cameras 152 and 153 can be restrained. For this reason, it is possible to obtain an advantage of correctly registering or identifying a person's face while the robot interacts with a person.

### Third Embodiment

Next, a third embodiment of the present invention will be described in detail with reference to drawings. The configuration of the third embodiment of the present invention is the same as the configuration shown in FIG. 2. In the following description, a portion (controller 120) different from the second embodiment will be described in detail.

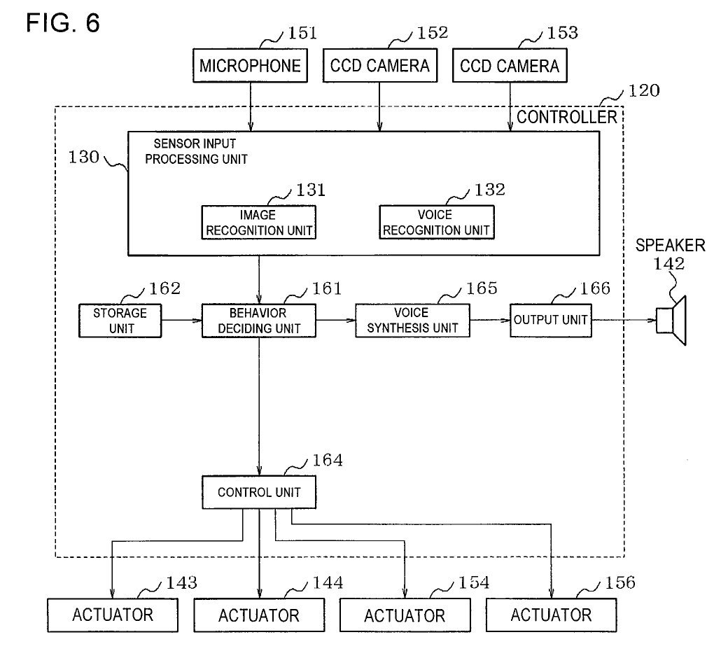

FIG. 6 is a block diagram showing an example of the mechanical configuration of a controller 120 of a robot 100 according to a third embodiment of the present invention. The controller 120 of the third embodiment of the present invention does not include an operation restraining unit 163 unlike the controller 120 of the second embodiment.

In this embodiment, a storage unit 162 stores an operation instruction that can be executed while an image processing unit (image recognition unit 131) performs a process for identifying or registering a person's face, and an operation instruction that can be executed while the image processing unit does not perform processes for identifying and registering a person's face. Further, if the image processing unit is identifying or registering a person's face, the behavior deciding unit 161 selects and outputs the operation instruction, which can be executed while the image processing unit (image recognition unit 131) performs a process for identifying or registering a person's face, from the storage unit 162. If the image processing unit does not identify and register a person's face, the behavior deciding unit selects and outputs the operation instruction, which can be executed while the image processing unit does not perform processes for identifying and registering a person's face, from the storage unit 162.

That is, the behavior deciding unit 161 receives voice recognition information, such as “Good morning” or “Good afternoon”; and an image recognition result, such as “One person exists” or “An ID of the person is k”, from the image recognition unit 131 as state recognizing information. If the voice recognition result is input, the behavior deciding unit 161 confirms whether the image recognition unit 131 is performing a process for registering a person's face or a process for identifying a face. If the image recognition unit 131 is performing the process for registering a face or the process for identifying a face, the behavior deciding unit 161 receives an operation instruction, which corresponds to the voice recognition result, of the operation instruction, which can be executed while the process for identifying or registering a face is performed, from the storage unit 162.

For example, an operation instruction of the robot 100, which corresponds to the voice recognition result of “Good morning”, has the contents of “A head 150 is shaken up and down and faces the front side”. A synthesized utterance instruction has the contents where the robot utters a person's name if the robot initially knows the person's name and then makes a synthesized utterance of “Good morning”. However, the synthesized utterance instruction is the operation instruction to be selected when the image recognition unit 131 performs the process for registering or identifying a face. Accordingly, an operation for shaking the head 150 up and down is performed below an upper limit of an operational range or speed not to hinder the process for registering or identifying a face even though the CCD cameras 152 and 153 are operated due to the operation. Since the upper limit is an eigenvalue of a robot system, the upper limit is a value that is determined for each system of the robot 100.

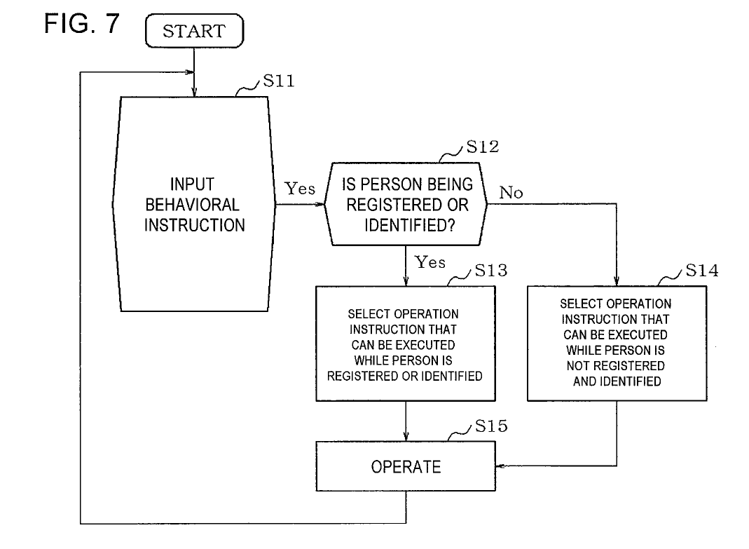

Next, the entire operation of a third embodiment of the present invention will be described in detail with reference to a flowchart of FIG. 7. If a behavioral instruction (for example, by voice) is input (Yes in Step S11 of FIG. 7), the robot 100 determines whether a person is being registered or identified (Step S12). If it is determined that the person is being registered or identified (Yes in Step S12), the robot 100 selects an operation instruction that can be executed while a person is registered or identified (Step S13).

If it is determined that a person is not being registered or identified (No in Step S12), the robot 100 selects an operation instruction that can be executed while a person is not registered and identified (Step S14). Then, the robot 100 is operated on the basis of the operation instruction (Step S15).

According to the third embodiment of the present invention, since the behavior deciding unit 161 includes the operation of the operation restraining unit 163 unlike in the second embodiment, it is possible to obtain an advantage of simplifying the configuration.

Meanwhile, if the image recognition unit 131 can detect a person from not a stereo image but image data input from a single CCD camera in the second and third embodiments of the present invention, only one CCD camera may be used. Further, the robot 100 may have a function that records an image of a person and sends the image of a person to an external terminal when the image is requested through an Internet. The robot 100 has been provided with the microphone 151, but it may be considered that the robot uses a wireless microphone.

Furthermore, the robot 100 may be provided with an infrared sensor, and may have a function of checking the body temperature of a child. In addition, the robot 100 may have a function of generating a map and a function of identifying its own position. Further, the robot 100 may be provided with a plurality of touch sensors. Furthermore, the robot 100 may receive a behavioral instruction from the outside through a network such as an Internet. Even in this case, an operation instruction is altered by the operation restraining unit 163 depending on the situation.

Furthermore, a series of processes has been performed by making the processor 121 (FIG. 3) execute a program in the second and third embodiments of the present invention, but a series of processes may be performed by dedicated hardware.

Meanwhile, the program has been stored in the memory 122 (FIG. 3), but may be temporarily or permanently stored (recorded) on a removable recording medium, such as a floppy (registered trademark) disk, a CD-ROM, a MO disk, a DVD, a magnetic disk, or a semiconductor memory. Further, the removable recording medium is provided as so-called package software, and the package software may be installed in the robot 100 (memory 122).

Furthermore, the robot 100 may install a program that is transmitted by wireless from a download site through an artificial satellite for digital satellite broadcasting, or a program that is transmitted by a cable through a network, such as a LAN or an Internet, on the memory 122. In this case, if the version of the program is upgraded, the program of which the version is upgraded is easily installed on the memory 122.

Herein, processing steps, which describe a program for making the processor 121 perform various processes, do not need to be necessarily performed in time series in order shown in the flowchart, and may be performed in parallel or individually. Further, the program may be executed by one processor 121, or may be distributed by a plurality of processors 121.

Furthermore, in another embodiment, a program may be loaded on a memory of an external computer of a robot 100 and executed by the external computer so as to remotely operate the robot 100 by wireless. The robot 100 may be provided with a wireless unit that communicates with an external computer by wireless, and a control unit that receives an instruction from the computer and is operated.

The configuration of the present invention has been described above, but the present invention includes the following aspects.

(1) According to the present invention, there is provided a robot that alters a behavior during a process for identifying or registering a person's face.

(2) The robot disclosed in (1) may include an image input means that receives an image and outputs image data; an image processing means that receives the image data and generates and outputs an image recognition result; a behavior processing means that decides a behavior and outputs a behavioral instruction; a restraint processing means that receives the operation instruction, alters the behavioral instruction so as to restrain the movement of the image input means if the image processing means is performing a process for identifying or registering a person's face, and outputs the altered behavioral instruction as an operation instruction; and an operation means that is operated on the basis of the operation instruction.

(3) The robot disclosed in (2) may include a restraint processing means. While the image processing means performs the process for identifying or registering a person's face, the restraint processing means alters the behavioral instruction so that the person's face does not deviate from the image, and outputs the altered behavioral instruction as an operation instruction.

(4) The robot disclosed in (2) may include the restraint processing means. While the image processing means performs the process for identifying or registering a person's face, the restraint processing means alters the behavioral instruction so that the moving speed of the image input means caused by the execution of the operation instruction has a predetermined value as an upper limit, and outputs the altered behavioral instruction as an operation instruction.

(5) The robot disclosed in (2) may include the restraint processing means. If it is determined that a plurality of person's faces exists in the image data, the restraint processing means alters the operation of each of the faces.

(6) The robot disclosed in (1) may include a CCD camera that receives an image and outputs image data; an image recognition unit that identifies or registers a person's face of the image data output from the CCD camera, and outputs restraint information, which requires the alteration or restraint of an operation if the image processing means is performing a process for identifying or registering a person's face; a microphone that collects voice and outputs voice data; a voice recognition unit that receives the voice data, recognizes voice, and outputs the voice as a voice recognition result; a behavior deciding unit that sequentially decides behaviors on the basis of the voice recognition result and outputs the behavior as a behavioral instruction; an operation restraining unit that outputs an operation instruction which is obtained by altering the behavioral instruction so as to restrain the operation of the CCD camera if the restraint information, which requires the alteration or restraint of the behavioral instruction and the operation, is input; and a control unit that controls an actuator on the basis of the operation instruction.

(7) The robot disclosed in (1) may include an image input means that receives an image and outputs image data; an image processing means that receives the image data and generates and outputs an image recognition result; a storage means that stores an operation instruction; a behavior deciding unit that selects and outputs an operation instruction, which can be executed while a process for identifying or registering a person's face is performed, from the storage means if the image processing means is performing a process for identifying or registering a person's face, and selects and outputs an operation instruction, which can be executed while processes for identifying and registering a person's face are not performed, from the storage means if processes for identifying and registering a person's face are not being performed; and an operation means that is operated on the basis of the operation instruction output from the behavior deciding unit.

(8) The robot disclosed in (1) may include a CCD camera that receives an image and outputs image data; an image recognition unit that identifies or registers a person's face of the image data output from the CCD camera and outputs an image recognition result; a microphone that collects voice and outputs voice data; a voice recognition unit that receives the voice data, recognizes voice, and outputs the voice as a voice recognition result; a storage means that stores an operation instruction; a behavior deciding unit that selects and outputs an operation instruction, which restrains the operation of the CCD camera and can be executed while a process for identifying or registering a person's face is performed, from the storage means if it is determined from the image recognition result that the image processing means is performing a process for identifying or registering a person's face, and selects and outputs an operation instruction, which does not restrain the operation of the CCD camera and can be executed while processes for identifying and registering a person's face are not performed, from the storage means if it is determined that processes for identifying and registering a person's face are not being performed; and a control unit that controls an actuator on the basis of the operation instruction.

(9) According to the present invention, there is provided a robot control method including steps that alter a behavior during a process for identifying or registering a person's face by a robot.

(10) The robot control method disclosed in (9) controls a robot that includes an image input means, a behavior processing means, a restraint processing means, and an operation means. The robot control method may include a step that receives an image and outputs image data by the image input means; a step that receives the image data and generates and outputs an image recognition result by the image processing means; a step that decides a behavior and outputs a behavioral instruction by the behavior processing means; a step that receives the operation instruction, alters the behavioral instruction so as to restrain the movement of the image input means if the image processing means is performing a process for identifying or registering a person's face, and outputs the altered behavioral instruction as an operation instruction by the restraint processing means; and a step that operates the operation means on the basis of the operation instruction.

(11) The robot control method disclosed in (10) may include a step that alters the behavioral instruction so that the person's face does not deviate from the image, and outputs the altered behavioral instruction as an operation instruction while the image processing means performs the process for identifying or registering a person's face, by the restraint processing means.

(12) The robot control method disclosed in (10) may include a step that alters the behavioral instruction so that the moving speed of the image input means caused by the execution of the operation instruction has a predetermined value as an upper limit and outputs the altered behavioral instruction as an operation instruction while the image processing means performs the process for identifying or registering a person's face, by the restraint processing means.

(13) The robot control method disclosed in (10) may include a step that alters the operation of each of the faces if it is determined that a plurality of person's faces exists in the image data, by the restraint processing means.

(14) According to the present invention, there is provided a robot control program for making a robot perform steps that alter a behavior during a process for identifying or registering a person's face.

(15) The robot control program disclosed in (14) controls a robot that includes an image input means, a behavior processing means, a restraint processing means, and an operation means. The robot control program may make the image input means perform a step that receives an image and outputs image data; may make the image processing means perform a step that receives the image data and generates and outputs an image recognition result; may make the behavior processing means perform a step that decides a behavior and outputs a behavioral instruction; may make the restraint processing means perform a step that receives the operation instruction, alters the behavioral instruction so as to restrain the movement of the image input means if the image processing means is performing a process for identifying or registering a person's face, and outputs the altered behavioral instruction as an operation instruction; and may make the operation means a step that operates on the basis of the operation instruction.

(16) The robot control program disclosed in (15) may make the restraint processing means perform a step that alters the behavioral instruction so that the person's face does not deviate from the image, and outputs the altered behavioral instruction as an operation instruction while the image processing means performs the process for identifying or registering a person's face.

(17) The robot control program disclosed in (15) may make the restraint processing means perform a step that alters the behavioral instruction so that the moving speed of the image input means caused by the execution of the operation instruction has a predetermined value as an upper limit and outputs the altered behavioral instruction as an operation instruction while the image processing means performs the process for identifying or registering a person's face.

(18) The robot control program disclosed in (15) may make the restraint processing means perform a step that alters the operation of each of the faces if it is determined that a plurality of person's faces exists in the image data.

This application claims priority from Japanese Patent Application No. 2006-177534 filed in the in the Japanese Patent Office on Jun. 28, 2006, the entire disclosure of which is incorporated herein by reference.

The present invention has been described above with reference to the embodiments. However, the present invention is not limited to the configuration, and it will be apparent to those skilled in the art that various modifications and changes may be made thereto within the scope and spirit of the invention.

1-15. (canceled)

16. A robot comprising:
an operation unit that operates each part of a robot;
an image input unit that receives an image and outputs image data;
an image processing unit that receives said image data and generates and outputs an image recognition result; and
an operation deciding unit outputting an operation instruction that restrains an operation for moving a portion on which said image input unit is mounted while said image processing unit performs a process for identifying or registering a person's face, and does not restrain the operation for moving the portion on which said image input unit is mounted while said image processing unit performs the process for identifying or registering the person's face,
wherein said operation unit operates each part of said robot on the basis of said operation instruction.

17. The robot according to claim 16,
wherein the image processing unit identifies said person's face that is included in said image data; registers said person's face; generates restraint information showing that an operation can be restrained while said process for identifying or registering the person's face is performed, and showing that an operation cannot be restrained while said process for identifying or registering the person's face is not performed; and outputs said image recognition result that includes said restraint information, and
said operation deciding unit includes:
a behavior processing unit that receives said image recognition result, decides a behavior on the basis of said image recognition result, and outputs a behavioral instruction, and
a restraint processing unit that receives said image recognition result and said behavioral instruction, and alters said behavioral instruction to restrain the operation for moving the portion on which said image input unit is mounted when said restraint information shows that the operation can be restrained, and not to restrain the operation for moving the portion on which said image input unit is mounted when said restraint information shows that the operation cannot be restrained, and outputs the altered behavioral instruction as an operation instruction.

18. The robot according to claim 17,
wherein said image processing unit detects said person's face that is included in said image data; identifies which registered face said person's face corresponds to; generates state recognizing information showing whether a person exists in said image data, the position of a person, and a registered ID of a person; and outputs said image recognition result that is included in said state recognizing information, and
the behavior processing unit includes
a storage unit that stores a plurality of behavioral instructions corresponding to said state recognizing information, and
a behavior deciding unit that receives said image recognition result, decides said behavioral instruction corresponding to said state recognizing information with reference to said storage unit, and outputs said behavioral instruction.

19. The robot according to claim 17,
wherein while said image processing unit performs the process for identifying or registering the person's face, the restraint processing unit alters the behavioral instruction so that an operating range of said image input unit is limited to prevent said person's face from deviating from the image input by said image input unit or so that the moving speed of said image input unit caused by the execution of said operation instruction has a predetermined value as an upper limit, and outputs the altered behavioral instruction as said operation instruction.

20. The robot according to claim 16,
wherein said operation unit includes a plurality of actuators that moves each of the parts of the robot, and a control unit that controls said plurality of actuators on the basis of said operation instruction,
said image input unit is a CCD camera,
said CCD camera is mounted in a head of said robot,
said image processing unit includes an image recognition unit that identifies or registers the person's face of said image data output from said CCD camera and outputs restraint information, which requires the alteration or restraint of an operation if a process for identifying or registering a person's face is being performed,
said operation deciding unit includes:
a microphone that collects voice and output voice data;
a voice recognition unit that receives said voice data, recognizes voice, and output the voice as a voice recognition result;
a behavior deciding unit that sequentially decides behaviors on the basis of said voice recognition result and outputs the behavior as a behavioral instruction; and
an operation restraining unit that outputs an operation instruction which is obtained by altering said behavioral instruction so as to restrain the operation for moving said head if said behavioral instruction and said restraint information are input, and
said control unit of said operation unit controls the actuator, which moves said head, so as to restrain the operation for moving said head on the basis of said operation instruction output from said operation deciding unit.

21. The robot according to claim 16, further comprising:
a storage unit that stores a first operation instruction that can be executed while said image processing unit performs the process for identifying or registering the person's face, and a second operation instruction that can be executed while processes for identifying and registering the person's face are not performed;
a behavior deciding unit that receives said image recognition result, selects and outputs said first operation instruction from said storage unit if said image processing unit is performing the process for identifying or registering the person's face, and selects and outputs said second operation instruction from said storage unit if said image processing unit is not performing the processes for identifying and registering the person's face; and
an operation unit that is operated on the basis of said first or second operation instruction.

22. The robot according to claim 16,
wherein said operation unit includes:
a plurality of actuators that moves each of the parts of the robot, and
a control unit that controls said actuators on the basis of said operation instruction,
said image input unit is a CCD camera,
said CCD camera is mounted in a head of said robot,
said image processing unit includes an image recognition unit that identifies or registers the person's face of the image data output from said CCD camera and outputs an image recognition result,
said robot includes a storage unit that stores an operation instruction that restrains an operation for moving said head and can be executed while said image processing unit performs the process for identifying or registering the person's face, and an operation instruction that does not restrain an operation for moving the head and can be executed while processes for identifying and registering the person's face are not performed,
said operation deciding unit includes:
a microphone that collects voice and output voice data,
a voice recognition unit that receives said voice data, recognizes voice, and outputs the voice as a voice recognition result, and
a behavior deciding unit that selects and outputs an operation instruction, which restrains the operation for moving said head and can be executed while said image processing unit performs the process for identifying or registering the person's face, from said storage unit if it is determined from said image recognition result that the image processing means is performing the process for identifying or registering the person's face, and selects and outputs an operation instruction, which does not restrain the operation for moving said head and can be executed while processes for identifying and registering the person's face are not performed, from said storage unit if it is determined that processes for identifying and registering the person's face are not being performed, and
said control unit of said operation unit controls the actuator, which moves said head, so as to restrain the operation for moving said head on the basis of said operation instruction output from said operation deciding unit.

23. A robot control method of controlling a robot including an operation unit that operates each part of a robot, an image input unit that receives an image and outputs image data, and an image processing unit that receives said image data and generates and outputs an image recognition result, the robot control method comprising:
receiving an image and outputting image data by said image input unit;
receiving said image data and generating and outputting an image recognition result by said image processing unit;
outputting an operation instruction that restrains an operation for moving a portion on which said image input unit is mounted while said image processing unit performs a process for identifying or registering a person's face, and does not restrain the operation for moving the portion on which said image input unit is mounted while said image processing unit performs the process for identifying or registering the person's face; and
moving each of the parts of said robot by said operation unit on the basis of said operation instruction.

24. The robot control method according to claim 23, further comprising:
identifying said person's face that is included in said image data;
registering said person's face;
generating restraint information showing that an operation can be restrained while said process for identifying or registering the person's face is performed, and showing that an operation cannot be restrained while said process for identifying or registering the person's face is not performed;
outputting said image recognition result that includes said restraint information;
deciding a behavior on the basis of said image recognition result, and outputting a behavioral instruction;
receiving said image recognition result and said behavioral instruction, and altering said behavioral instruction to restrain the operation for moving the portion on which said image input unit is mounted when said restraint information shows that the operation can be restrained, and not to restrain the operation for moving the portion on which said image input unit is mounted when said restraint information shows that the operation cannot be restrained, and outputting the altered behavioral instruction as an operation instruction; and
moving each of the parts of said robot by said operation unit on the basis of said operation instruction.

25. The robot control method according to claim 24, further comprising:
detecting said person's face that is included in said image data;
identifying which registered face said person's face corresponds to;
generating state recognizing information showing whether a person exists in said image data, the position of a person, and a registered ID of a person;
deciding said behavioral instruction corresponding to said state recognizing information and outputting the behavioral instruction as said behavioral instruction; and
altering said behavioral instruction and outputting the altered behavioral instruction as an operation instruction.

26. The robot control method according to claim 24, further comprising:
altering the behavioral instruction so that an operating range of said image input unit is limited to prevent said person's face from deviating from the image input by said image input unit or so that the moving speed of said image input unit caused by the execution of the operation instruction has a predetermined value as an upper limit while said image processing unit performs the process for identifying or registering the person's face, and outputting the altered behavioral instruction as the operation instruction.

27. A robot control program executed by a computer and controlling a robot, the robot including an operation unit that operates each part of a robot, an image input unit that receives an image and outputs image data, and an image processing unit that receives said image data and generates and outputs an image recognition result,
wherein said computer functions as:
a means that makes said image input unit receive an image and output image data,
a means that makes said image processing means receives said image data and generate and output an image recognition result,
a means that outputs an operation instruction that restrains an operation for moving a portion on which said image input unit is mounted while said image processing unit performs a process for identifying or registering a person's face, and does not restrain the operation for moving the portion on which said image input unit is mounted while said image processing unit performs the process for identifying or registering the person's face, and
a means that moves each of the parts of said robot by said operation unit on the basis of said operation instruction.

28. The robot control program according to claim 27,
wherein said computer functions as:
a means that identifies said person's face included in said image data,
a means that registers said person's face,
a means that generates restraint information showing that an operation can be restrained while said process for identifying or registering the person's face is performed, and showing that an operation cannot be restrained while said process for identifying or registering the person's face is not performed,
a means that outputs said image recognition result including said restraint information,
a means that decides a behavior on the basis of said image recognition result, and outputting a behavioral instruction,
a means that receives said image recognition result and said behavioral instruction, and altering said behavioral instruction to restrain the operation for moving the portion on which said image input unit is mounted when said restraint information shows that the operation can be restrained, and not to restrain the operation for moving the portion on which said image input unit is mounted when said restraint information shows that the operation cannot be restrained, and outputting the altered behavioral instruction as an operation instruction, and
a means that moves each of the parts of the robot by said operation unit on the basis of said operation instruction.

29. The robot control program according to claim 28,
wherein said computer functions as:
a means that identifies said person's face that is included in said image data,
a means that identifies which registered face said person's face corresponds to,
a means that generates state recognizing information showing whether a person exists in said image data, the position of a person, and a registered ID of a person,
a means that decides said behavioral instruction corresponding to said state recognizing information and outputting the behavioral instruction as said behavioral instruction, and
a means that alters said behavioral instruction and outputting the altered behavioral instruction as an operation instruction.

30. The robot control program according to claim 28,
wherein said computer functions as:
a means that alters the behavioral instruction so that an operating range of said image input unit is limited to prevent said person's face from deviating from said image input by said image input unit or so that the moving speed of said image input unit caused by the execution of the operation instruction has a predetermined value as an upper limit while said image processing unit performs the process for identifying or registering the person's face, and outputs the altered behavioral instruction as the operation instruction.
